(19) United States
(12) Patent Application Publication
(10) Pub. No.: US 2026/0280014 A1
(43) Pub. Date: Sep. 17, 2026

(54) BATTERY CASE

(71) Applicant: HONDA MOTOR CO., LTD., Tokyo (JP)

(72) Inventor: So KUNII, Tokyo (JP)

(73) Assignee: HONDA MOTOR CO., LTD., Tokyo (JP)

(21) Appl. No.: 19/542,682

(22) Filed: Feb. 18, 2026

(30) Foreign Application Priority Data
Mar. 14, 2025 (JP) 2025-040951

(51) Int. Cl. H01M 50/262; H01M 50/24; H01M 50/271

(52) U.S. Cl. CPC H01M 50/262; H01M 50/24; H01M 50/271

(57) ABSTRACT

A battery case that accommodates a battery. The battery case has a lower case on which the battery is placed, and an upper cover that has a flange portion overlapping an upper surface of a peripheral edge portion of the lower case. The upper cover covers the lower case from above via a seal member. The upper cover is fastened to the lower case at the flange portion by a plurality of fastening members. The upper cover has a bent portion formed by bending a peripheral edge portion of the flange portion upward.

### CROSS-REFERENCE TO RELATED APPLICATIONS

This application is based on and claims priority under 35 USC 119 from Japanese Patent Application No. 2025-040951 filed on Mar. 14, 2025, the entire content of which is incorporated herein by reference.

### TECHNICAL FIELD

The present disclosure relates to a battery case that accommodates a battery.

### BACKGROUND ART

In recent years, researches and developments have been conducted on a secondary battery which contributes to improvement in energy efficiency in order to allow more people to have access to affordable, reliable, sustainable and advanced energy.

For example, JP7551089B discloses a structure related to a housing of a battery pack used as a power supply source of an electric automobile. In the technique disclosed in JP7551089B, edge portions of a lower case and an upper cover are bent downward, and the lower case and the upper cover are coupled by a fastening unit while such bent portions are in contact with each other. With such a configuration, a sealing property of the housing is improved without adding a sealing step or the like.

Unlike the battery pack in JP7551089B, a battery pack in which a lower case and an upper cover are sealed using a seal member is also common. When the seal member is used, the upper cover may be deformed by a reaction force of the seal member when the seal member is compressed, and there is room for improvement from the viewpoint of the sealing property.

### SUMMARY OF INVENTION

The present disclosure provides a battery case capable of improving a sealing property in a case where a lower case and an upper cover are sealed using a seal member.

An aspect of the present disclosure is a battery case that accommodates a battery, the battery case having:

a lower case on which the battery is placed; and

an upper cover that has a flange portion overlapping an upper surface of a peripheral edge portion of the lower case, the upper cover covering the lower case from above

via a seal member, in which

the upper cover is fastened to the lower case at the flange portion by a plurality of fastening members, and

the upper cover has a bent portion formed by bending a peripheral edge portion of the flange portion upward.

According to the aspect of the present disclosure, the sealing property of the battery case can be improved.

### BRIEF DESCRIPTION OF DRAWINGS

Exemplary embodiment(s) of the present invention will be described in detail based on the following figures, wherein:

FIG. 1 is a perspective view of a battery pack including a battery case according to an embodiment of the present disclosure;

FIG. 2 is an exploded perspective view of the battery pack;

FIG. 3 is a partial perspective view of an upper cover fastened to a lower case;

FIG. 4 is a top view of a flange portion of the upper cover on which a curved portion is formed; and

FIG. 5 is a cross-sectional view taken along line V-V in FIG. 4.

### DESCRIPTION OF EMBODIMENTS

Hereinafter, an embodiment of a battery case of the present disclosure will be described with reference to the accompanying drawings. The drawings are viewed in directions of reference signs. In the present specification and the like, in order to simplify and clarify the description, a front-rear direction, a left-right direction, and an upper-lower direction are described according to directions viewed from a driver of a vehicle, and in the drawings, a front side of the vehicle is shown as Fr, a rear side is shown as Rr, a left side is shown as L, a right side is shown as R, an upper side is shown as U, and a lower side is shown as D.

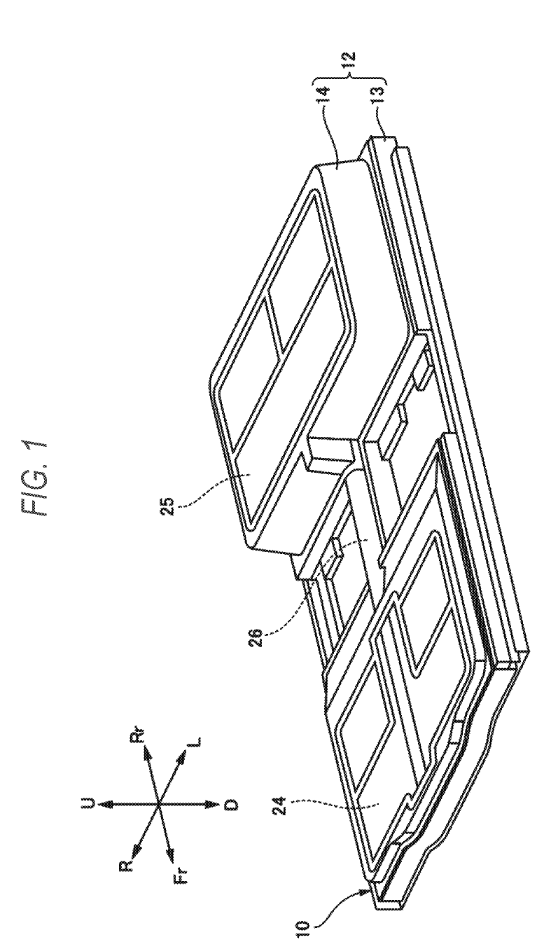

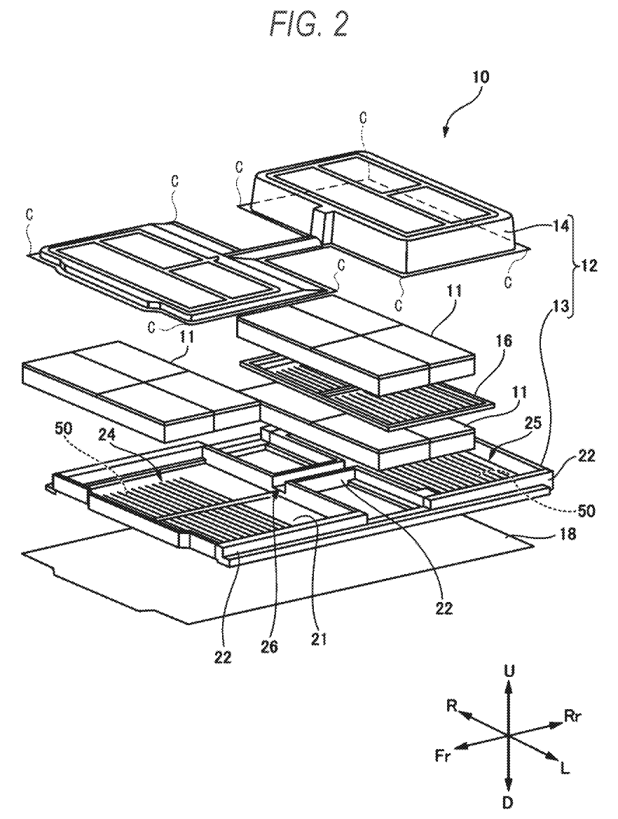

FIG. 1 is a perspective view of a battery pack 10 including a battery case 12 according to the embodiment of the present disclosure. FIG. 2 is an exploded perspective view of the battery pack 10. The battery pack 10 is mounted under a floor of the vehicle and stores power to be supplied to a motor or the like serving as a drive source of the vehicle. The vehicle on which the battery pack 10 is mounted is, for example, an electric vehicle such as a battery electric automobile, a hybrid vehicle (including a plug-in hybrid vehicle), or a fuel cell vehicle.

The battery pack 10 includes a battery 11, the battery case 12 that accommodates the battery 11, and an under cover 18 that is formed of a heat insulating material such as foamed polypropylene and covers the battery case 12 from below.

A plurality of batteries 11 are accommodated in the battery case 12. Each battery 11 is, for example, a lithium ion battery or a nickel-metal hydride battery. Each battery 11 includes a plurality of battery cells. Although not illustrated, each battery cell includes a positive electrode, a negative electrode, an electrolyte, and an exterior body that accommodates these components, and is, for example, a pouch-type cell, a square cell, or a cylindrical cell. The electrolyte may be a liquid or a solid. The battery 11 may be implemented as a battery module in which the plurality of battery cells (for example, pouch-type cells or square cells) are stacked and modularized, or may be implemented as a plurality of battery cells that are not modularized.

The battery case 12 includes a lower case 13 on which the battery 11 is placed and an upper cover 14 that covers the lower case 13 from above.

The lower case 13 includes a base plate 21 on which the battery 11 is placed, and a frame member 22 joined to the base plate 21. The lower case 13 has a tray shape that can accommodate the battery 11.

The base plate 21 has a substantially rectangular shape in a top view. The base plate 21 is formed by pressing a metal material. The metal material of the base plate 21 is, for example, aluminum or an aluminum alloy, which allows a weight of the battery case 12 to be reduced. The base plate 21 may also be made of iron.

A water jacket 50 is provided at a lower portion of the base plate 21, and a temperature of the battery 11 is adjusted (reduced or increased) by a coolant flowing through the water jacket 50. The under cover 18 covers the water jacket 50 from below.

The frame member 22 is produced by performing extrusion molding on a metal material. The frame member 22 is, for example, an aluminum extruded material produced by performing extrusion molding on aluminum or an aluminum alloy. Since the frame member 22 is made of the aluminum extruded material, the frame member 22 has a high rigidity and a light weight. The frame member 22 is joined to an upper surface of the base plate 21 by welding or the like, and constitutes a side wall of the lower case 13.

The lower case 13 includes a front-side accommodation space 24 that is provided on a front side to accommodate the battery 11, a rear-side accommodation space 25 that is provided on a rear side to accommodate the battery 11, and an arrangement space 26 which is provided between the front-side accommodation space 24 and the rear-side accommodation space 25 and in which a bus bar, a harness, and the like (not shown) are arranged.

The front-side accommodation space 24 and the rear-side accommodation space 25 are each defined and formed by the frame member 22 in a substantially rectangular shape in a top view. In the front-side accommodation space 24, the batteries 11 are accommodated in one tier. The batteries 11 are accommodated in the rear-side accommodation space 25 via the bracket 16 in two upper and lower tiers. In addition to the batteries 11, for example, an electrical connection box in which an electrical component (an input and output circuit, a fuse, or the like) to be connected to the batteries 11 is mounted, and a control device such as an electronic control unit (ECU) may be accommodated in the front-side accommodation space 24 and the rear-side accommodation space 25. In addition, the number of tiers in the upper-lower direction of the batteries 11 accommodated in the front-side accommodation space 24 and the rear-side accommodation space 25 can be set as desired, and for example, the batteries 11 may be accommodated in one tier in the rear-side accommodation space 25 or the batteries 11 may be accommodated in two tiers in the front-side accommodation space 24.

The upper cover 14 is fixed to an upper surface of the frame member 22 to seal the inside of the battery case 12. Specifically, the upper cover 14 has a shape along the upper surface of the frame member 22, which defines and forms the front-side accommodation space 24, the rear-side accommodation space 25, and the arrangement space 26, and covers these spaces from above.

The upper cover 14 is formed by pressing a metal plate material. The metal plate material of the upper cover 14 is, for example, aluminum or an aluminum alloy, which allows a weight of the battery case 12 to be reduced. The upper cover 14 may also be made of iron.

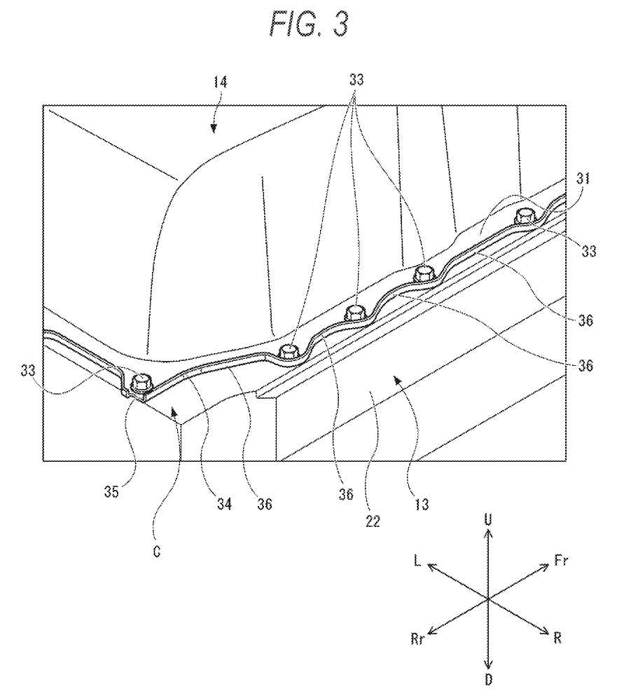

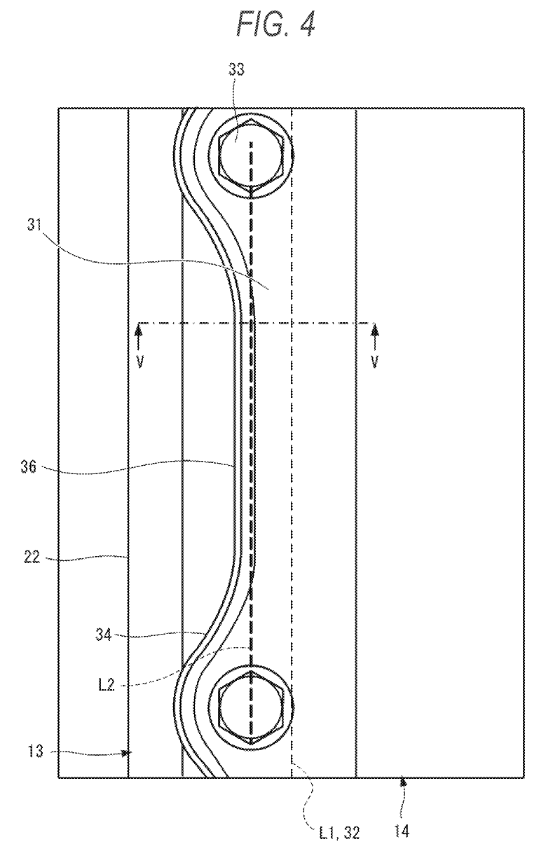

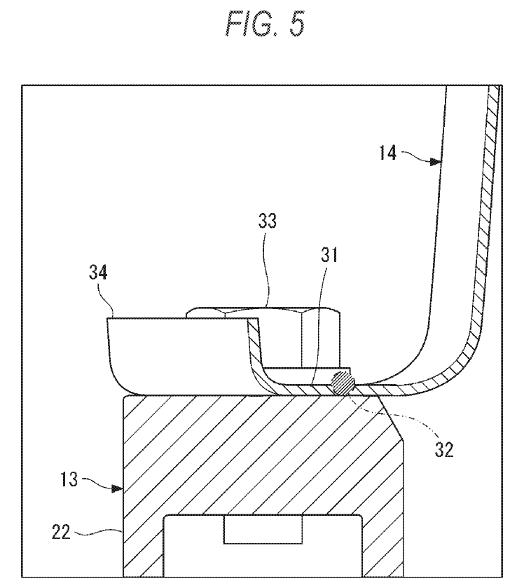

FIG. 3 is a partial perspective view of the upper cover 14 fastened to the lower case 13, specifically, a perspective view of the vicinity of a corner part C at a right rear end of the upper cover 14. FIG. 4 is a top view of a flange portion 31 of the upper cover 14 on which a curved portion 36 is formed. FIG. 5 is a cross-sectional view taken along line V-V in FIG. 4. Hereinafter, a detailed structure of the upper cover 14 will be described with reference to FIGS. 3 to 5.

A peripheral edge portion of the upper cover 14 has the flange portion 31 that overlaps a peripheral edge portion upper surface of the lower case 13 (the upper surface of the frame member 22). The flange portion 31 is superimposed on the peripheral edge portion upper surface of the lower case 13 via a seal member 32 (see FIGS. 4 and 5), and is fastened to the lower case 13 by a plurality of fastening members 33 such as bolts.

The seal member 32 exhibits favorable sealing performance by being compressed between the peripheral edge portion upper surface of the lower case 13 and a lower surface of the flange portion 31. The seal member 32 is, for example, a liquid gasket (FIPG: formed in place gasket). Although the seal member 32 shown in FIG. 5 is shown in a state before compression in order to describe a position of the seal member 32, the seal member 32 is actually in close contact in a compressed state between the lower surface of the flange portion 31 and the peripheral edge portion upper surface of the lower case 13. The seal member 32 is applied along a seal position L1 (thin broken line) set on the peripheral edge portion upper surface of the lower case 13 as shown in FIG. 4. The seal position L1 is located closer to an inside of the battery case 12 than a line L2 (thick broken line) connecting centers of adjacent fastening members 33.

A peripheral edge portion of the flange portion 31 has a bent portion 34 formed by being bent upward. Since the bent portion 34 increases a second moment of area of the flange portion 31, deformation of the flange portion 31 can be reduced when the seal member 32 is compressed. Accordingly, the seal member 32 can exhibit favorable sealing performance, and a sealing property of the battery case 12 can be improved.

A height position of the bent portion 34 is lower than an upper end of each fastening member 33. In this way, even when water is accumulated in the flange portion 31, it is possible to prevent the entire fastening member 33 from being immersed in the water and to prevent the fastening member 33 from rusting. In addition, as compared to a case where the height position of the bent portion 34 is higher than the upper end of the fastening member 33, it is possible to not only reduce a weight of the upper cover 14 but also reduce a possibility that the bent portion 34 interferes during assembly of the battery case 12.

The upper cover 14 has a cutout portion 35 formed by cutting out a part of the bent portion 34. The cutout portion 35 functions as a drain path for draining water accumulated on the flange portion 31 from above the flange portion 31. The water accumulated on the flange portion 31 is, for example, water splashed by the vehicle when traveling in a puddle or condensation generated due to a temperature difference between the inside and the outside of the battery case 12.

The cutout portion 35 is preferably provided at the corner part C of the upper cover 14 as shown in FIG. 2. That is, since the water accumulated on the flange portion 31 is easily directed to the corner part C due to acceleration, deceleration, rolling, or the like of the vehicle, performance of drainage by the cutout portion 35 can be improved.

The upper cover 14 has the curved portion 36 formed by curving the flange portion 31 toward the inside of the battery case 12 between adjacent fastening members 33. A plurality of curved portions 36 are formed in the upper cover 14. Each curved portion 36 reduces a contact area between the flange portion 31 of the upper cover 14 and the lower case 13 by curving the peripheral edge portion of the flange portion 31 toward the inside of the battery case 12, and brings a center of gravity of the flange portion 31 closer to a position where the seal member 32 is provided (seal position L1). Accordingly, a surface pressure between the lower case 13 and the upper cover 14 at the position of the seal member 32 increases, and the sealing property of the battery case 12 can be improved. In addition, by reducing the contact area between the flange portion 31 and the lower case 13, an amount of the seal member 32 to be applied can also be reduced.

As shown in FIG. 4, an innermost part of the curved portion 36 is located at a middle section between the adjacent fastening members 33. In this way, the surface pressure between the lower case 13 and the upper cover 14 can be substantially uniform between the adjacent fastening members 33.

The innermost part of the curved portion 36 overlaps the line L2 connecting the centers of the adjacent fastening members 33. In this way, the curved portion 36 can be prevented from being excessively close to the inside of the battery case 12, and the seal member 32 can be prevented from protruding to an outer side of the upper cover 14.

Further, the innermost part of the curved portion 36 may be formed linearly. In this way, since the innermost part of the curved portion 36 is linear and overlaps the line L2 connecting the centers of the adjacent fastening members 33, the center of gravity of the flange portion 31 can be closer to the position of the seal member 32. Accordingly, the surface pressure between the lower case 13 and the upper cover 14 at the position of the seal member 32 can be further increased. The curved portion 36 may not necessarily have a portion formed linearly between the adjacent fastening members 33 (see FIG. 3).

Although the embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

In the present specification, at least the following matters are described. In the parentheses, the corresponding constituent elements and the like in the above embodiment are shown as an example, but the present invention is not limited thereto.

(1) A battery case (battery case 12) that accommodates a battery (battery 11), the battery case including:

a lower case (lower case 13) on which the battery is placed; and

an upper cover (upper cover 14) that has a flange portion (flange portion 31) overlapping an upper surface of a peripheral edge portion of the lower case, the upper cover covering the lower case from above via a seal member (seal member 32), in which

the upper cover is fastened to the lower case at the flange portion by a plurality of fastening members (fastening members 33), and

the upper cover has a bent portion (bent portion 34) formed by bending a peripheral edge portion of the flange portion upward.

According to (1), since a second moment of area of the flange portion is increased by the bent portion formed at the peripheral edge portion of the upper cover, deformation of the flange portion can be reduced when the seal member is compressed. Thus, a sealing property of the battery case can be improved.

(2) The battery case according to (1), in which

a height position of the bent portion is lower than an upper end of each of the fastening members.

According to (2), even when water is accumulated in the flange portion, the entire fastening member is not immersed in the water, and thus rusting of the fastening member can be prevented. In addition, assemblability of the battery case can be improved and a weight thereof can be reduced.

(3) The battery case according to (1) or (2), in which

the upper cover further has a cutout portion (cutout portion 35) formed by cutting out a part of the bent portion.

According to (3), water accumulated in the flange portion can be drained from the cutout portion.

(4) The battery case according to (3), in which

the cutout portion is provided at a corner part (corner part C) of the upper cover.

According to (4), for example, when the battery case is mounted on a vehicle, water accumulated in the flange portion is easily directed to the corner part due to acceleration, deceleration, or rolling of the vehicle, and thus performance of drainage can be improved.

(5) The battery case according to any one of (1) to (4), in which

the upper cover has a curved portion (curved portion 36) formed by curving the

flange portion, between the adjacent fastening members, toward an inside of the battery case.

According to (5), a contact area between the flange portion of the upper cover and the lower case is reduced by the curved portion formed to be curved toward the inside of the battery case. In addition, a center of gravity of the flange portion can be brought close to a position of the seal member. Thus, a surface pressure between the lower case and the upper cover at the position of the seal member increases, and the sealing property of the battery case can be improved. Further, since the contact area between the flange portion and the lower case is reduced, an amount of the seal member to be applied can be reduced.

(6) The battery case according to (5), in which

an innermost part of the curved portion is located at a middle section between the adjacent fastening members.

According to (6), the surface pressure between the lower case and the upper cover can be substantially uniform between the adjacent fastening members.

(7) The battery case according to (5) or (6), in which

an innermost part of the curved portion overlaps a line (line L2) connecting centers of the adjacent fastening members.

According to (7), since the curved portion is not excessively close to the inside of the battery case, the seal member can be prevented from protruding to an outer side of the upper cover.

(8) The battery case according to (7), in which

the innermost part of the curved portion is formed linearly.

According to (8), since the innermost part of the curved portion is linear and overlaps the line connecting the centers of the adjacent fastening members, the center of gravity of the flange portion can be closer to the position of the seal member. Thus, the surface pressure between the lower case and the upper cover at the position of the seal member can be further increased.

What is claimed is:

1. A battery case that accommodates a battery, the battery case comprising:
a lower case on which the battery is placed; and
an upper cover that has a flange portion overlapping an upper surface of a peripheral edge portion of the lower case, the upper cover covering the lower case from above via a seal member, wherein
the upper cover is fastened to the lower case at the flange portion by a plurality of fastening members, and
the upper cover has a bent portion formed by bending a peripheral edge portion of the flange portion upward.

2. The battery case according to claim 1, wherein
a height position of the bent portion is lower than an upper end of each of the fastening members.

3. The battery case according to claim 1, wherein
the upper cover further has a cutout portion formed by cutting out a part of the bent portion.

4. The battery case according to claim 3, wherein
the cutout portion is provided at a corner part of the upper cover.

5. The battery case according to claim 1, wherein
the upper cover has a curved portion formed by curving the flange portion, between the adjacent fastening members, toward an inside of the battery case.

6. The battery case according to claim 5, wherein
an innermost part of the curved portion is located at a middle section between the adjacent fastening members.

7. The battery case according to claim 5, wherein
an innermost part of the curved portion overlaps a line connecting centers of the adjacent fastening members.

8. The battery case according to claim 7, wherein
the innermost part of the curved portion is formed linearly.
